(19) United States
(12) Patent Application Publication
(10) Pub. No.: US 2003/0055758 A1
(43) Pub. Date: Mar. 20, 2003

(54) Method and apparatus for identifying investor profile

(76) Inventors: Gurdip Singh Sidhu, Kuala Lumpur (MY); Chin Wei Min, Kuala Lumpur (MY)

Correspondence Address: Erwin J. Basinski, Morrison & Foerster LLP, 425 Market Street, San Francisco, CA, 94105-2482, US

(21) Appl. No.: 10/128,910

(22) Filed: Apr. 22, 2002

(30) Foreign Application Priority Data
Apr. 24, 2001 (MY) PI 20011905

(51) Int. Cl. G06F 17/60

(52) U.S. Cl. 705/35

(57) ABSTRACT

An investor profiling process (200) presents (210) an investor with an investment environment and provides (225) investible assets. Several (240) time periods over a year are simulated during which the investor is provided updated status of his investment and additional information (230). In each time period the investor has the opportunity to reallocate (235) his investible assets. The reallocation data is later analyzed (245) to determined asset value protection (AVP) and income versus growth (IVG) characteristics of the investor. The AVP and IVG of the investor are then used to identify (250) an investor profile from a variety of predefined investor profiles.

FIG. 2 accompanies the abstract.

### CROSS-REFERENCE TO RELATED APPLICATIONS

This application is related to and claims priority from Malaysian Patent Application No. PI120011905 filed on Apr. 21, 2001 which is hereby incorporated fully herein by reference.

### FIELD OF THE INVENTION

The present invention relates to identifying investor profile of an investor, and more particularly to identifying investor profile of an investor through an interactive process.

### BACKGROUND OF THE INVENTION

the past, investments in stocks and bonds were the concerns of bankers, industrialist and the more wealthy members of society. However, presently, it has become relatively common if not necessary, for an employee in a company to own stock or equity in that company. Thus, making employees investors.

Investors now include the more traditional large institutional investors, and a growing number of individual investors or consumers. In addition, there are a wide variety of investment instruments available to these investors. Broadly, investment instruments can be divided into fixed income funds and equities, where fixed income funds include cash term deposits and bonds, and equities, as are known in the art.

Typically, an investor maintains an investment portfolio which comprises investments in a variety of investment instruments, and investors diversify their investment portfolio by allocating their investible assets among the variety of investment instruments. The proportions of allocations by an investor among the variety of investment instruments depends on the investment profile of that investor.

An investor's investment profile, which will also be referred to as investor's profile, has two primary investment characteristics that influence the investor's allocation of his investible assets. The first investment characteristic is an investor's asset value protection (AVP) or risk tolerance characteristic, and the second is an investor's income verses growth (IVG) or investment objectives characteristic.

Asset value protection (AVP), sometimes referred to as risk tolerance, refers to an investor's willingness to accept fluctuations in the value of his principal investible assets. Risk represents the chance of a reduction in the value of his principal investible assets, or put plainly, the chance of an investor losing money which has been invested. Therefore, an investor who has a high AVP characteristic has a low appetite for risk. This means that an investor with such an AVP characteristic has a very low tolerance to market fluctuation.

In contrast, an investor who has a low AVP characteristic has a greater appetite for risks. An investor with such an AVP characteristic is willing to tolerate greater fluctuations in the value of his invested assets in the investment instrument market, with the hope of gaining higher returns from his investments over a relatively longer period of time. Generally, investment in investment instruments are governed by the principle that the greater the risk, the higher the expected returns.

The IVG characteristic reflects an investor's investment objective, which could either be to gain a reasonable high level of income or dividend yield from his investments, or to gain capital appreciation from the investment. If an investor prefers income to growth, that investor would allocate a larger portion of his investible assets to fixed income instruments, and would also allocate a portion of his investible assets to a dividend paying equity. However, the allocation to the dividend paying equity would depend on that investor's AVP characteristic. For example, if that investor prefers growth to income, then that investor would instead invest in equities that have a potential for capital appreciation.

One fundamental aspect of investing is balancing risk and returns. Institutional investors have at their disposal substantial resources in man and machine to determine the balance between risk and returns when making their investment decisions. In addition, such investors are bound by company policies and the like, within which they operate. In contrast, a consumer has to determine his or her own balance between risks and returns.

There is now a growing market of investment instruments that are being made available directly to consumers. To encourage consumer interest and participation, it is necessary to raise a consumer's knowledge and awareness in investing. An important part of this effort is helping a consumer determine his or her investor profile.

When an investor knows and understands his investor profile, the investor will be better able to invest his investible assets. As described earlier, an investor's profile provides an indication of two investment characteristics. In particular, the investor's appetite for risks or risk tolerance, and investment objectives. Hence, investment profiles vary from that of an investor who wants to preserve the value of his investments on the one hand, to an investor who wants aggressive growth on the other.

A common method of assisting an investor, particularly a new investor, in determining his or her investment profile is to provide the investor with a questionnaire. The questionnaire typically provides investment scenarios and requires responses from the investor. The responses are taken to be indicative of the investment characteristics of the respondent. Then, depending on a score attained by the investor based on the responses to the questionnaire, a particular investor profile is identified as being that of the respondent and the characteristics of the identified investor profile are described. In some instances, the description includes investment instruments that should be considered by the investor as these investment instruments match the described investor profile. In some other instances, the respondent is not provided with an investor profile but with only the recommended investment instruments.

A disadvantage of this method is that the investor responds to the questions in a passive environment which does not present an investor the opportunity to provide responses in a variety of situations. Hence, this method does not take into account a variety of situations that tend to present themselves when investing in the real world.

Another method provided via the Internet by Credit Suisse, through its website at www.credit-suisse.com using a feature known as an Investment Manager, requires a consumer to allocate and reallocate investment instruments in a virtual investment environment over several time periods. In addition, the investor is provided with the performance of the investment instruments after each allocation by numerical and graphical representation of the value of the investment instruments. An investor profile is then presented.

A disadvantage of this method is that the allocation and re-allocation among the investment instruments are made by the investor based solely on the performance of the investment instruments as provided to the investor i.e. by way of the numerical and graphical representation of the value of the investment instruments. This method does not provide for, nor consider other influences that an investor tends to take into account when allocating his investible assets.

### BRIEF SUMMARY OF THE INVENTION

The present invention seeks to provide a method and apparatus for identifying investor profile which overcomes, or at least reduces, the abovementioned problems of the prior art.

Accordingly, in one aspect, the present invention provides a method for identifying investor profile of an investor, the method comprising the steps of:

a) presenting an investment environment to the investor, wherein the investment environment includes a plurality of investment instruments;

b) providing the investor with investible assets;

c) providing the investor with information relating to a predetermined initial status of the investment environment;

d) receiving initial allocation data from the investor;

e) allocating the investible assets among the plurality of investment instruments in accordance with the initial allocation data;

f) providing the investor with additional information, wherein the additional information includes updated values of at least one of the plurality of investment instruments, and wherein the additional information includes predetermined information identified as being information from at least one of a variety of predetermined information sources;

g) receiving re-allocation data from the investor;

h) allocating the investible assets among the plurality of investment instruments in accordance with the re-allocation data;

i) repeating steps (f) to (h) a predetermined number of iterations while tracking the re-allocation data for each iteration to produce tracking allocation data; and

j) identifying at least one predetermined investor profile of a plurality of predetermined investor profiles using at least some of the tracking allocation data.

In another aspect, the present invention provides an apparatus for identifying investor profile of an investor, the apparatus comprising:

a user interface for presenting an investment environment, the investment environment comprising:

an allocator for selecting an initial investment allocation among a predetermined variety of investment instruments, and the allocator for selecting subsequent investment allocations among the variety of investment instruments; and

a plurality of display locations for displaying information, the information comprising current investible assets of the investor, current values of the variety of investment instruments, and information from a variety of information sources, the plurality of display locations for displaying subsequent investible assets of the investor, subsequent values of the variety of investment instruments, and subsequent information from a variety of information sources, and the plurality of display locations for displaying an investor profile of the investor; and

a controller coupled to the user interface for receiving the initial investment allocation and for providing the current investible assets of the investor, current values of the variety of investment instruments, and information from a variety of information sources, the controller for receiving subsequent investment allocations and for providing subsequent investible assets of the investor, subsequent values of the variety of investment instruments, and subsequent information from a variety of information sources, and the controller for determining the investor profile from a variety of predefined investor profiles from at least some of the subsequent investment allocations, and for providing the investor profile to the user interface.

### BRIEF DESCRIPTION OF THE DRAWINGS

An embodiment of the present invention will now be fully described, by way of example, with reference to the drawings of which:

FIG. 1 shows a finctional block diagram of an investor profiler in accordance with the present invention; FIG. 1A shows representative portfolio combinations.

FIG. 2 shows a flowchart detailing the operation of the investor profiler in FIG. 1;

FIG. 3 shows a flowchart detailing a portion of the flowchart in FIG. 2;

FIG. 4 shows an investment recommendation system that incorporates the investor profiler in FIG. 1;

FIG. 5 shows an investment environment of the investment recommendation system in FIG. 4; and

FIGS. 5A-H show content presented at various times in the investment environment in FIG. 5.

### DETAILED DESCRIPTION OF THE DRAWINGS

An invertor interacts with an investor profiler software program to allocate investible assets among a variety of investment instruments in a simulated investment environment. The investor profiler presents the value of the investment instruments, and information associated with a variety of information sources to simulate a real world investment environment, to the investor. The investor allocates and reallocates the investible assets among the variety of investment instruments over a number of time periods. The steps of reallocating investible assets by the investor and providing updated information to the investor over several times periods simulate the passage of time, and the investor's allocations of investible assets among the variety of investment instruments in each time period is stored. The allocations made by the investor are then analyzed to determine degrees of prominence of the IVG and AVP characteristics of the investor. Subsequently, the degrees of prominence are translated to IVG and AVP ratings that are then employed to identify one of a variety of predetermined investor profiles as that of the particular investor's profile.

In addition, all the predetermined investor profiles share a common investment instrument classification scheme, and real world investment instruments that have been classified in accordance with this classification scheme, are optionally presented to the investor for consideration and selection based on the identified investor profile of the particular investment.

Hence, the present invention advantageously provides an investor profiler that determines an investor's characteristics from responses to information presented to the investor in the simulated investment environment, where the information is identified as coming from a variety of information sources. This allows the investor profiler to determine the information sources which are more likely to influence an investor, and identifies the investor profile by advantageously taking this aspect of an investor's behavior into account.

The investor is presented with a variety of informations and all these are used by the investor to arrive at his decision at each stage of the simulation. The investor's reaction at different stages of the simulation carry different weighting on the assessment of the investor profile, and hence, indirectly how the investor reacts to different information influences the profile.

In addition, the present invention allows classified investment instruments that match the classification of investment instruments of an identified investment profile to be presented to the investor, as a means of direct marketing of investment instruments. Hence, allowing such investment instruments to be marketed directly to the audience that is more likely to be interested in investing in those investment instruments.

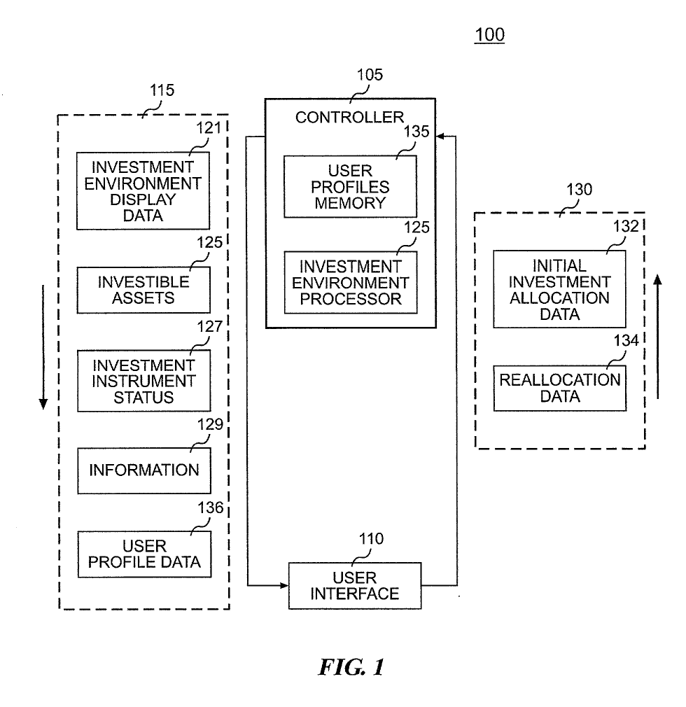

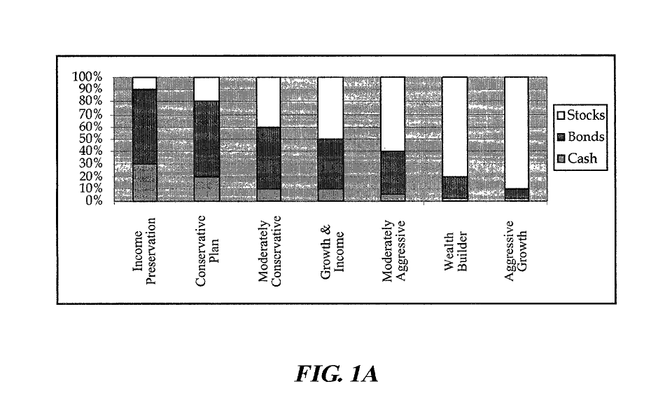

In FIG. 1 an investor profiler 100 includes a controller 105 that is coupled to a user interface 110. The controller 105 provides presentation information 115 to the user interface 110 for presentation to an investor. For the purposes of this description, a user of the user interface 110 will be referred to as an investor, however, investors will also include potential investors and also interested parties.

The investor is an individual. However, to the extent that a group of individuals have between them common defined investment objectives and risks, such a group is also considered an investor.

The presentation information 115 includes investment environment display data 121, investible asset data 125,investment instrument status 127,information 129,and investor profile data 136.The investment environment display data 121 includes graphical data and text, and arrangement instructions to display the graphical data and text for presenting an investment environment. The investible asset data 125,the investment instrument status 127,the information 129, and the investor profile data 136 comprise elements that are displayed within the investment environment. A more detailed description of the investment environment will be provided later.

The controller 105 is also coupled to the user interface 110 to receive investor input data 130. The user input data 130 includes initial investment allocation data 132 and reallocation data 134. The controller 105 includes an investment environment processor 125 that produces the investment environment display data 121. In addition, the investment environment processor 125 also receives the user input data 130, and produces the investible asset data 125, the investment instrument status 127, the information 129, and the investor profile data 136.

The controller 105 further includes an investor profile memory 135 that stores a number of predetermined investor profiles, and at the end of an investor profiling process, the controller 105 identifies one of the user profiles 135 as matching the profile of the investor. The investment environment processor 125 then provides corresponding investor profile data 136 to the user interface 110, and the user interface 110 then presents the investor profile data 136 of the identified investor profile. There are seven investor profiles that have been developed in accordance with the present invention. Each investor profile can include a variety of investment instruments divided between fixed income funds and equities. Cash and bonds are categorized as fixed income investments, and as is known in the art, cash and bonds are investments that are suitable for investors with high AVP characteristics.

The equities are primarily classified into high risk and low risk, and the higher risk equities and lower risk equities are further classified into growth-bias equities and income-bias equities. Hence, there are four classifications for equities namely, higher risk income equities, higher risk growth equities, lower risk income equities, and lower risk growth equities.

TABLE 1

| | Investment | | | | | | | |
|---|---|---|---|---|---|---|---|---|
| | Characteristic | | | | | | | |
| | Asset | | | | | | | |
| | value | Income vs. | | | Equities | | | |
| | protection | growth | Fixed Income | | Higher | Higher | Lower | Lower |
| Investor | (AVP) | (IVG) | Funds | | Risk | Risk | Risk | Risk |
| profile | Rating | Rating | Cash | Bonds | Income | Growth | income | Growth |
| Income | High | High | 40% | 50% | — | — | 10% | — |
| Preservation | | | | | | | | |
| Conservative | High | Medium | 20% | 60% | — | — | 10% | 10% |
| Plan | | | | | | | | |
| Moderately | Medium | High | 25% | 35% | 20% | — | 20% | — |
| Conservative | | | | | | | | |
| Growth & | Medium | Medium | 10% | 40% | 15% | 10% | 5% | 20% |
| Income | | | | | | | | |
| Moderately | Medium | Low | 5% | 35% | — | 20% | — | 40% |
| Aggressive | | | | | | | | |
| Wealth | Low | Medium | 5% | 15% | 30% | 30% | 10% | 10% |
| Builder | | | | | | | | |
| Aggressive | Low | Low | 2% | 8% | — | 70% | — | 20% |
| Growth | | | | | | | | |

With reference to TABLE 1 the seven user profiles are labeled as follows: Income Preservation, Conservative Plan, Moderately Conservative, Growth & Income, Moderately Aggressive, Wealth Builder, and Aggressive Growth, which are set out in the first column. The second and third columns are for AVP and IVG ratings of an investor, and both of these ratings are graded into degrees of prominence namely, high, low and medium. The ratings provide an indication of the degree of prominence the AVP and IVG characteristics of an investor, and are different for each of the seven investor profiles listed in the first column. A description of these investor profiles and how the AVP and IVG ratings are derived for each of these investor profiles will be provided later.

It should be noted that there are two combinations of AVP and IVG scores which are not assigned to an investor profile. These are the combinations of a high rating for AVP and a low rating for IVG; and a low rating for AVP, and a high rating for IVG.

These two combinations of AVP and IVG ratings are not plausible because both these combinations are contradictory. To elaborate, the first combination would represent an individual with a high AVP rating who also prefers growth to income. However, a person who has a high AVP rating has a propensity for safety indicating a low appetite for risks and prevention of loss in value his investments. Therefore, it would be contradictory for an investor to want high capital growth, as growth assets are risky and the chance of a loss in the value of his investments is higher.

Similarly, for the second combination, an investor with a low AVP rating and a high IVG rating would have a higher risk tolerance. This indicates that this investor would be willing to accept greater market fluctuations, and thus should maximize his potential gain by choosing growth rather than income generating funds. However, the high IVG rating suggests that the investor should invest in income funds. Hence these two combinations are contradictory.

When an investor has these extremely rare combinations of AVP ad IVG ratings, the closest investor profile will automatically be identified as the investor profile of that investor. For example, for an investor whose AVP and IVG ratings are high and low respectively, the Moderately Aggressive investor profile is identified. And, for an investor whose AVP and IVG ratings are low and high respectively, that investor is identified as a Wealth Builder.

Each of the seven investor profiles has an associated investment portfolio, and each investment portfolio includes a variety of investment instruments comprising Cash, Bonds, and Equities. The equities are further classified into Higher Risk Income, Higher Risk Growth, Lower Risk Income, and Lower Risk Growth, equities. For each of the investment portfolios, different proportions of an investment portfolio are allocated to different investment instruments and different

classifications of equities in accordance with the investment characteristics of the associated investor profile.

With reference to FIG. 1A, each of the investment portfolios and the proportions of the investment instruments associated with each investor portfolio is shown. It can be seen that an investment portfolio for an investor profile having a high AVP rating and a high IVG rating,

such as the Income Preservation investor profile, has a higher allocation for fixed income funds, such as cash and bonds, and a much lower allocation for equities. Similarly, an investment portfolio for an investor profile having a low AVP score and a low IVG score, such as the Aggressive Growth investor profile has a higher allocation for equities and a much lower allocation to fixed income finds.

Returning now to FIG. 1, it will be appreciated by one skilled in the art that the investor profiler can be implemented as an interactive computer program on a stand alone computer. The controller 105 comprises the computer's microprocessor operating under the control of a software program, and the user interface comprises the monitor and keyboard. The software program provides the functionality of the investment environment processor 125, and the computer memory would store the software program as well as provide the investor profiles memory for storing the seven investor profiles.

Alternatively, in a computer network operating environment, the controller may be provided by one of the computers on the network and the user interface comprises any of the monitors and keyboards of any of the computers on the network. This would extend to computer networks that include the Internet.

Further, in an Internet environment, the controller can comprise a program, such as a Java applet, that is downloaded from a host computer to a client computer, and executed on the client computer. The monitor and keyboard of the client computer would then provide the user interface.

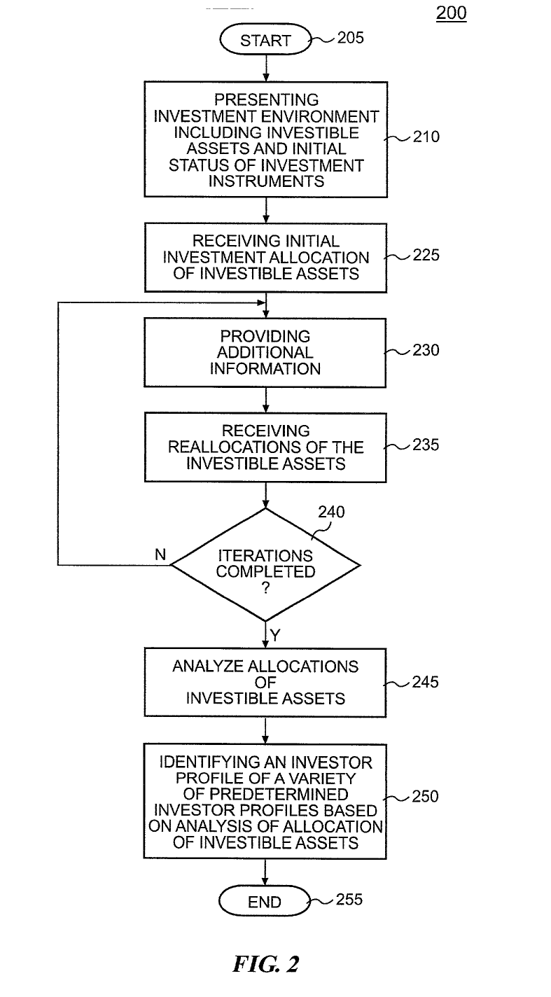

With additional reference now to FIG. 2, the operation of the investor profiler 100 starts 205 with presenting 210 an investment environment to an investor. This is accomplished by the controller 105 sending the investment environment display data 121 to the user interface 110. The presentation of the investment environment includes presenting the investible assets, provided by the investible asset data 125, and an initial investment instrument status is included in the investment environment. The initial investment instrument status is provided by the investment instrument status 127.

Next an initial allocation of the investible assets among investment instruments in the investment environment is received 225 in the form of the initial investment allocation data 132, from the investor provided via the user interface 110. Subsequently, additional information relating to the investment environment is provided 230 to the investor. The additional information comprises updated investment environment display data 121, updated value of the investible assets 125, updated investment instrument status 127 indicating the value of investment instruments in the investment environment, and updated information 129.

Next, reallocation data is received 235 from the investor, which, as before, is provided by the investor via user interface 100 as reallocation data 134. The steps of providing 230 additional information relating to the investment environment, and receiving 235 reallocation data 134 is repeated until a predetermined number of iterations 240 are completed. The iterations cover a number of time periods. In this description, a number of time periods over a simulated one year period are provided, with a final allocation of investible assets being provided to the investor at the end of that year.

When the iterations 240 are completed, the allocation data 132 and the reallocation data 134 from each reallocation is analyzed 245 by the investment environment processor 125, and subsequently, one of a variety of the predetermined investor profiles in the investor profile memory 135 is identified 250. The identified 250 investor profile reflects the investor profile of the investor using the investor profiler 100, and the operation of the investor profiler 100 then ends 255.

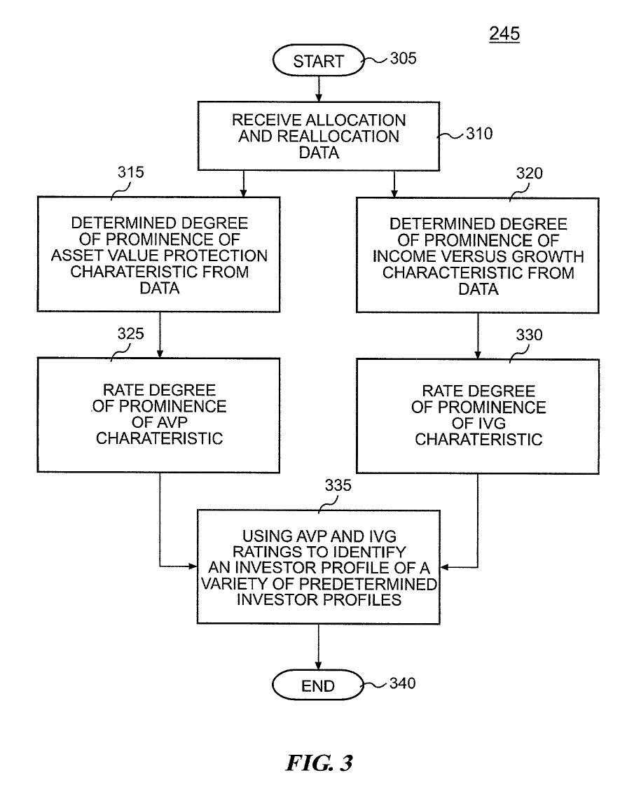

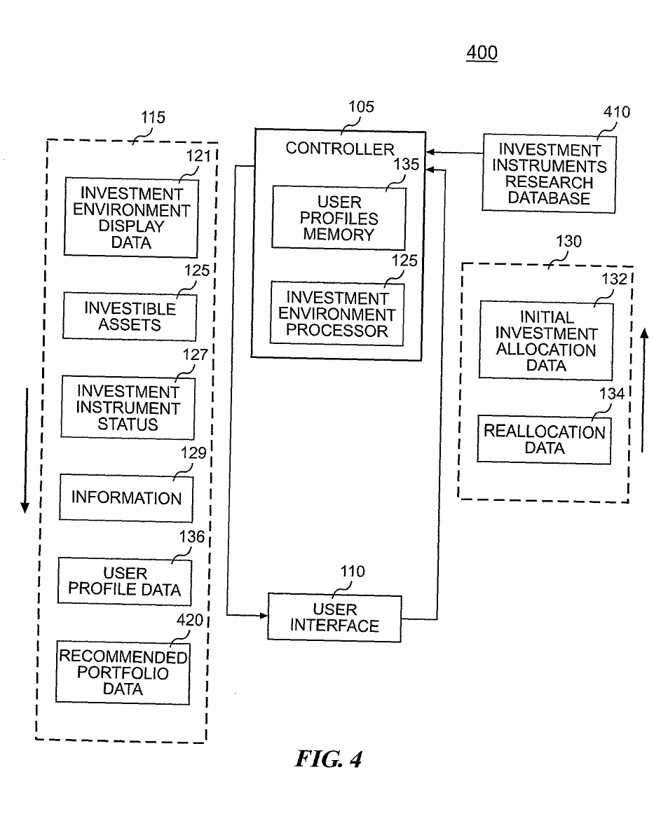

With additional reference now to FIG. 3, the step 245 comprises a process which describes the analysis of the allocations made by an investor. The process starts 305 with receiving 310 the allocation 132 and reallocation data 134 provided by the investor. The degree of prominence of the AVP characteristic of the investor is determined 315 from the received data 132,134 using an AVP algorithm which is described later. This is followed by rating 325 the degree of prominence of the AVP characteristic of the investor using an AVP rating scheme that will also be described later.

Separately, the degree of prominence of the IVG characteristic of the investor is determined 320 from the received data 132,134 using an IVG algorithm, to be described later, and this is then followed by rating 330 the degree of prominence of the IVG characteristic of the investor using an IVG rating scheme that will also be described later.

Subsequently, the AVP and the IVG ratings are used 335 in conjunction with TABLE 1 to identify one of the seven investor profiles as being the investor profile of the investor. Thus, bringing the process to an end 340.

Referring now to FIG. 4, an investment recommendation system 400 includes the investor profiler 100 and further includes an investment instrument research database 410 coupled to the controller 105, and where the presentation data 115 includes recommended portfolio data 420. The investment instrument research database 410 includes a listing of a variety of real world investment instruments, and when the investment instruments are equities, the equities include a corresponding classification in accordance with the four equity classifications described earlier i.e. higher risk income, higher risk growth, lower risk income and lower risk growth.

The classification of the equities in the investment instrument research database 410 can be performed using a manual process, where skilled analysts reviews reports on a particular equity and classifies that equity into one of the four classifications. The classifications are then stored in the research database 410. Alternatively, an automated process may be employed where particular criteria of equities to be included in the investment instrument research database 410 are used to classify the equities in accordance with a predetermined process. Borderline equities may be identified and reviewed manually.

The recommended portfolio data 420 provides a listing of equities having a classification, where an identified investor profile includes the same classification of equities.

The investment recommendation system 400 assists an investor in identifying their investor profile from seven predetermined investor profiles, as described earlier, using the investor profiler 100. In addition, the system 400 also presents investment instruments that match the identified investor profile, where the recommendation is based on research by a research organization. Note that either an internal or external research organization, or both, may be employed. The prerequisite for any research organizations that are employed are that equities be classified in accordance with the four classifications, and with some standard classification criteria.

The system 400 captures and stores an investor's input in the form of user input data 130, when the investor allocates and reallocates his investible assets in an investment environment displayed by the user interface 110. The investor's inputs eventually results in the investor being identified as having one of seven predetermined investor profiles, as described earlier, and the investor is then provided with investment research information on individual equities within each classification of his identified profile.

Thus, the present invention, as described, identifies an investor's profile, advantageously guides the investor to appropriate equities in accordance with the investor's profile, and can optionally allow the investor to track or directly transact those equities.

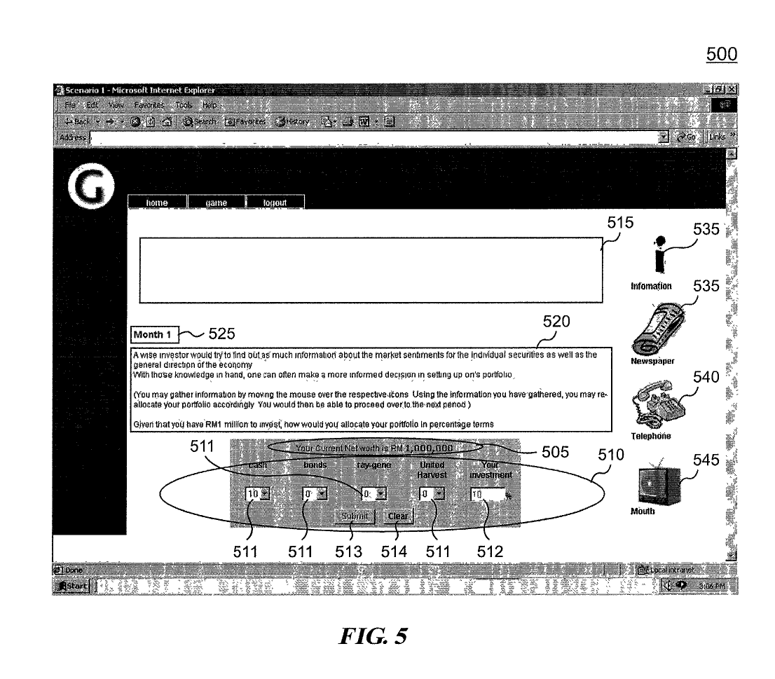

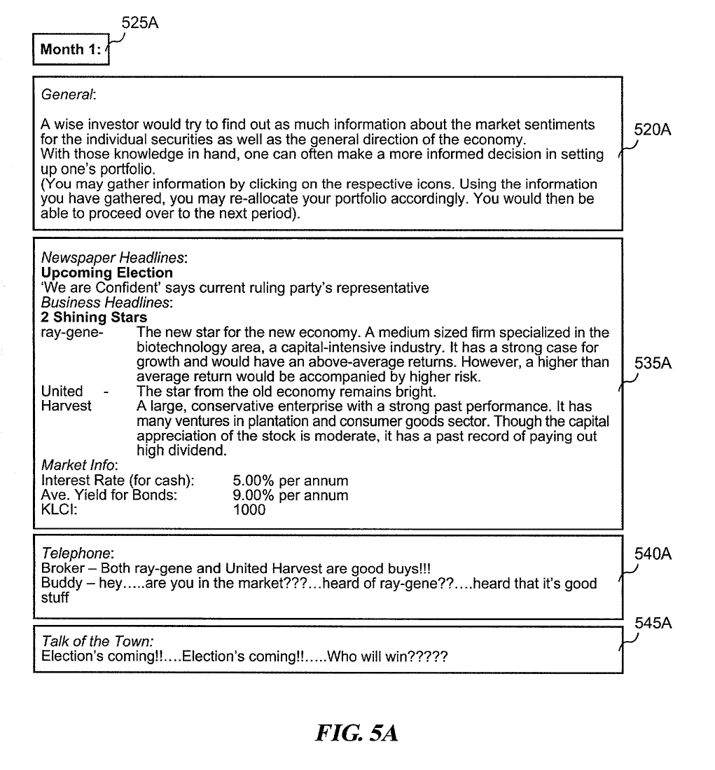

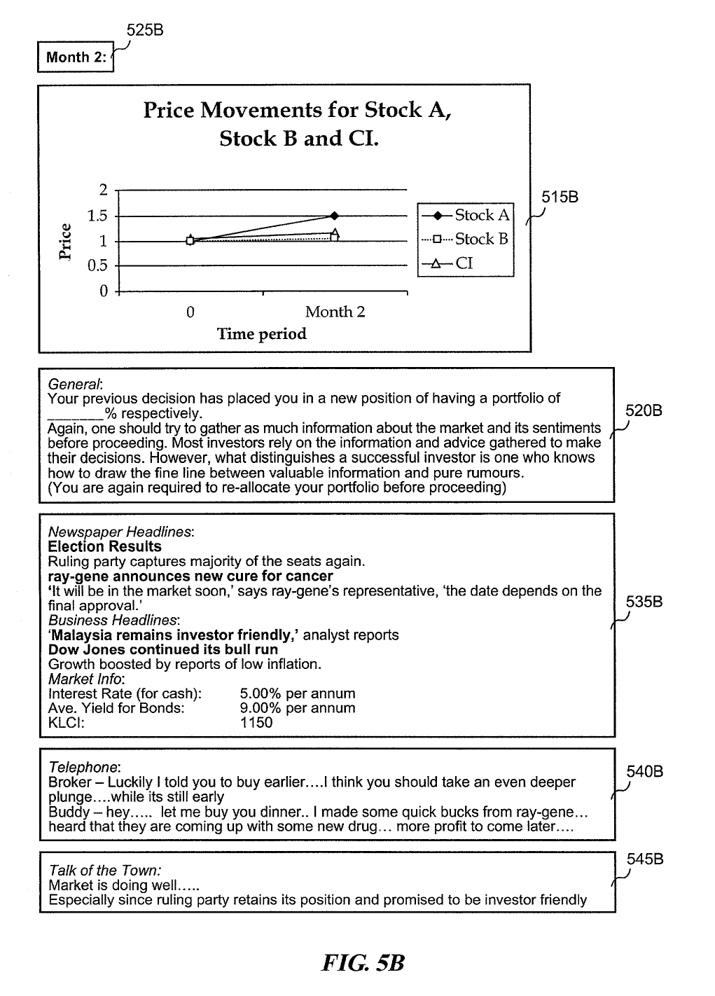

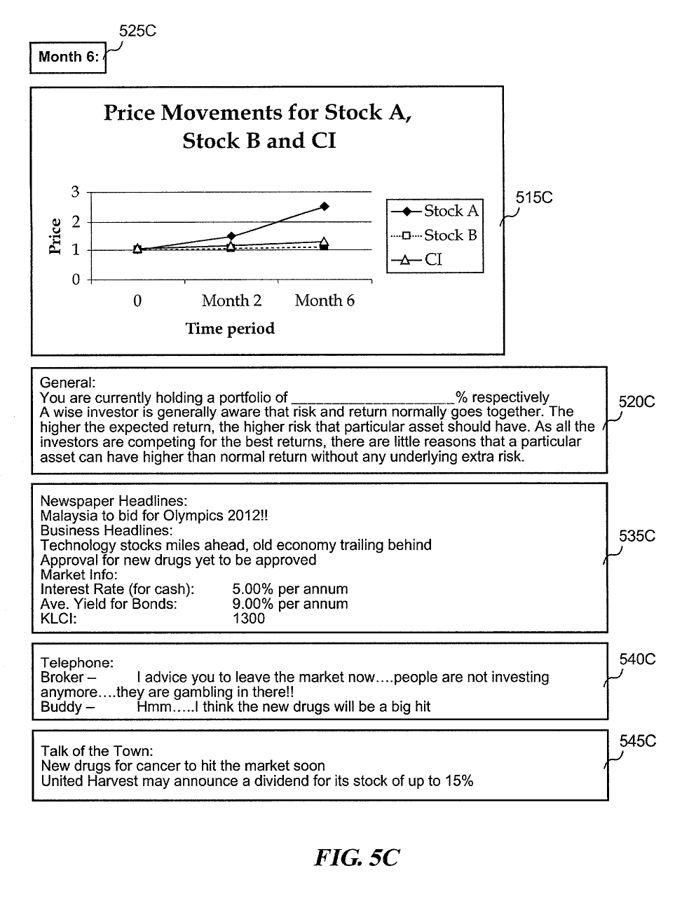

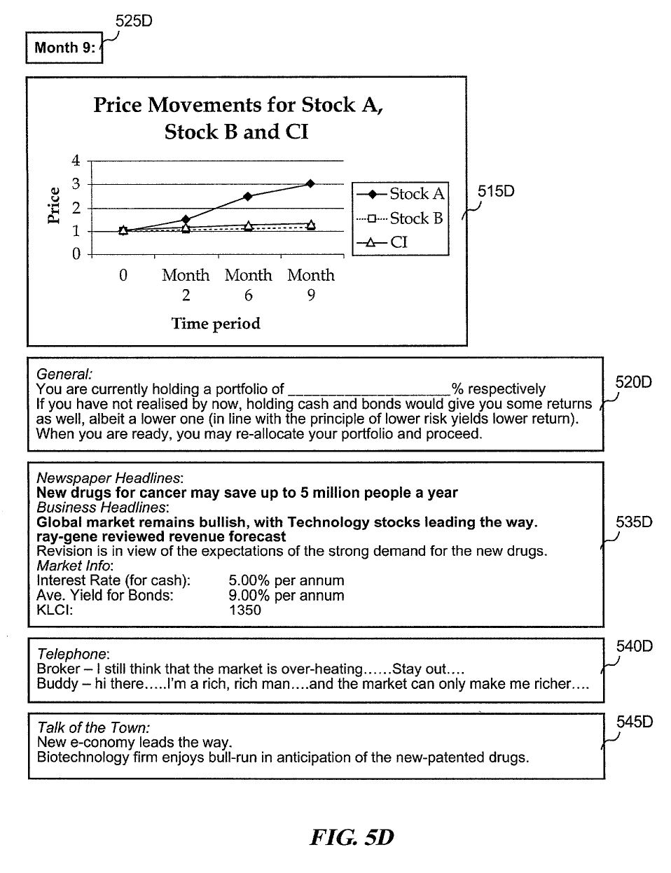

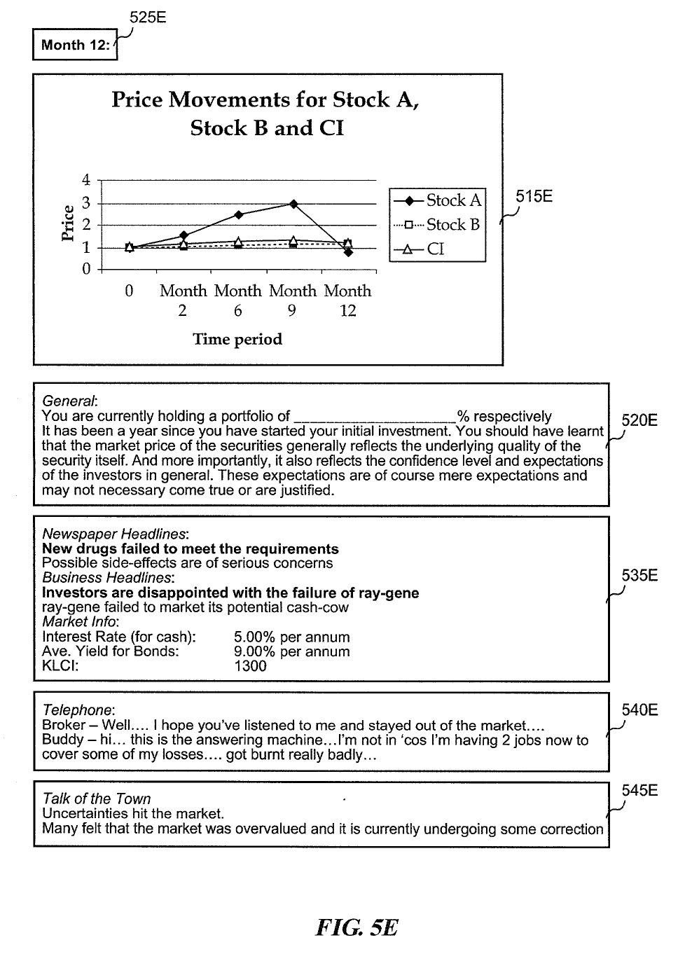

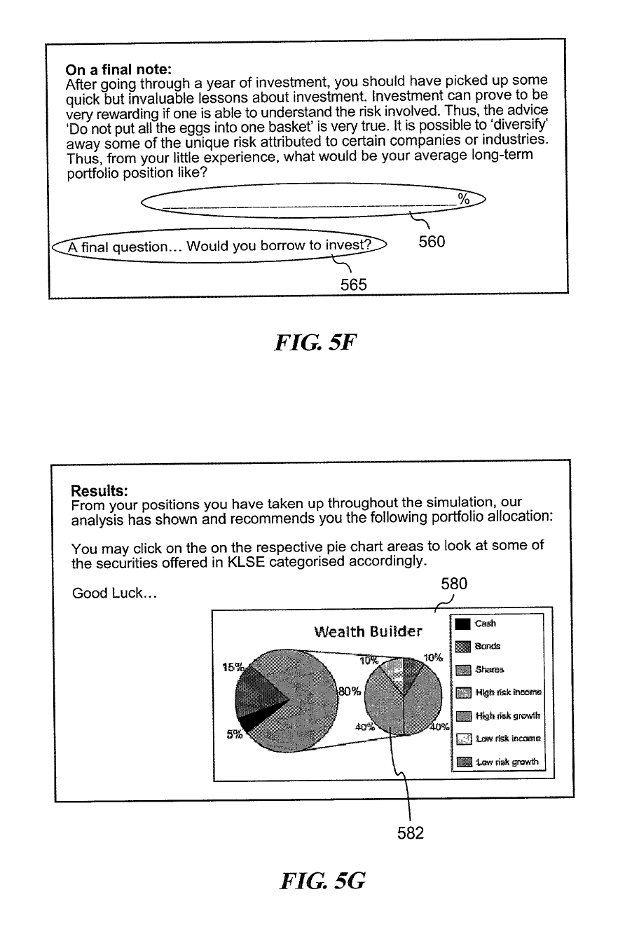

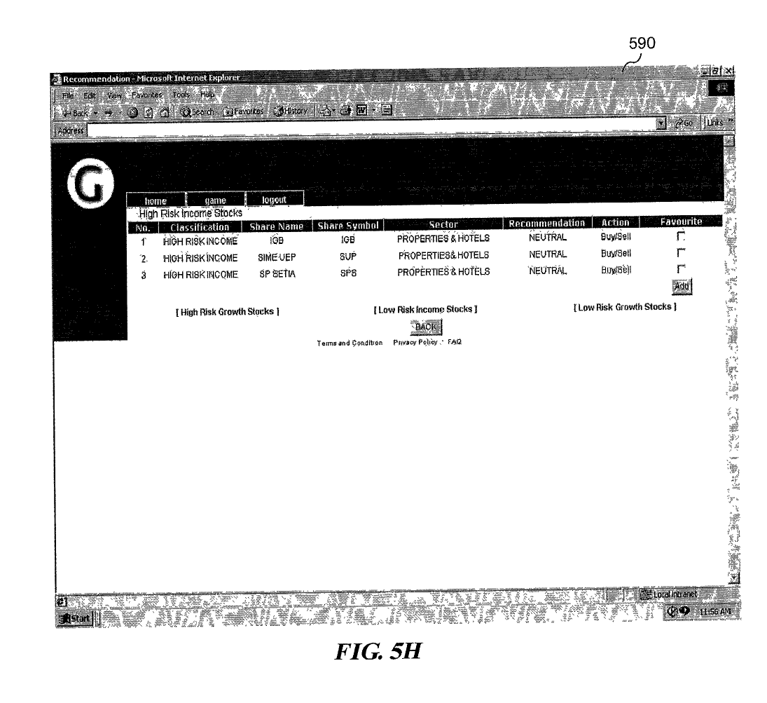

With additional reference to FIG. 5, an investment environment 500 is displayed on the user interface 110 of the investment recommendation 400. The investment environment is shown in a window of a Browser application which is running on a computer (not shown). The computer has access to the Internet, and particularly to another computer (not shown) which hosts the controller 105 of investment recommendation system 400.

In addition, an investor using the user interface 110, is provided with a sum of money to invest along with information, in particular, information relating to investments. The information provided to the investor includes information about two fictitious companies having different business profiles. The investor is required to progress through four time periods extending over a year, and in each time period, the investor is given the opportunity to re-allocate his investment portfolio. The investor's decisions will be influenced by a combination of factors including market prices of investment instruments in the investment environment, publicly available information as well as personal opinions of analyst and/or observers. How the investor reacts to the information which is provided to him is determined from how the investor allocates his investible assets among the variety of investment instruments. Through the observation of the investor's allocations, we can determine the investor's risk level (degree of prominence of AVP characteristic) and his preference over income or growth (degree of prominence of IVG characteristic). In addition, the nett worth of the investor's assets, which include the current value of his investments, is computed for each time period and presented to the investor. However the investor's nett worth is not employed in determining the investor's profile.

The investment environment 500 includes an indication of investible assets 505 in the form of a substantial amount of money, which an investor can invest in four different investment instruments. Here, the amount is one million ringgit. The investible assets 505 reflects the current nett worth of the investor, and will be updated through each time period as the investor progresses through the investor profiling process 200.

It will be appreciated that where the investment environment 500 is presented in a Browser delivered over the Internet, the currency of the investible assets can be changed automatically to match the geographic location using, for example, the geographic portion of the domain name of the investor's computer.

An allocator 510 allows an investor to allocate portions of the investible assets among the four investment instruments. The investment instruments are cash, bonds, and equities of the two fictitious companies, Ray-Gene and United Harvest. The allocator 510 has four input locations 511 in which the investor enters selected proportions of the investible assets, in percentage of the investible assets or net worth, allocated to each of the investment instruments. There is also a window 512 that that displays the total percentage of the investible assets that has been allocated by the investor, and Submit 513 and Cancel 514 buttons allow an investor to submit or correct his allocation of the investible assets in the input locations 511. Note that, for an investor to progress from one timer period to the next time period, an allocation must be entered, for example, by clicking on the Submit 513 button.

A graph display area 515 shows a graph that reflects the performance of the equities of the two companies throughout the profiling process 200. In addition, the graph also includes a well-known stock index. As the description relates to use in Malaysia, a Malaysian stock index known as the Kuala Lumpur Composite Index (KLCI) is also tracked on the graph.

Further, the investment environment 500 has a comments area 520, and a time period indicator 525 that shows the current time period in the profiling process 200, and a variety of icons. There is a Help icon 530, that provides an investor with assistance in relation to frequently asked questions, a glossary, detail description on how to use the investment recommendation system 400, and, if there is a disclaimer one could be included here.

There are also icons that represent a variety of information sources. The icons are a newspaper 535, a telephone 540 and a mouth 545. The newspaper icon 535 represents information sources such as newspaper headlines, business headlines, and market information. Similarly, the telephone icon 540 represents information sources such as that obtained from a broker via a telephone call, or from a friend, for example, via a telephone call. In addition, the mouth icon 545 represents information which is categorized as “talk of the town”. Whenever any of the icons is selected by the investor, using for example a point and click action, the relevant information associated with the icon is provided. Of course the information that is provided will vary dependent on the time period, and hence will change through the profiling process 200.

FIGS. 5A-E provide the content presented in the investment environment 400 in chronological sequence, from the first time period representing the first month, through the subsequent time periods representing the second month, the sixth month, the ninth month and the twelfth month, and a final reallocation,

FIG. 5A-E also includes the information that is presented to the investor directly 525A-E, 51 5A-E and 520A-E, and information presented to the investor when the various information source icons 535A-E, 540A-E and 545A-E are selected.

FIG. 5F provides an indication 560 of the final nett worth of the investor, and there is also a question 565 presented to the investor to determine whether the investor would consider borrowing money to invest.

FIG. 5G presents a graphical representation 580 of an identified investor profile that approximates the investor profile of the investor based on the investor's allocation of his investible assets. The graphical representation includes a variety of investment instruments and classifications, and the proportions of the investment instruments and classifications constitute a portfolio which matches the identified investor profile.

The graphical presentation 580 allows an investor to select any investment instrument or classification in the portfolio to obtain a listing 490 of specific recommended real world investment instruments. For example, with reference to FIG. 5H, when the High Risk Income equity portion 582 is selected, the listing 590 of a variety of equities that have been pre-classified to be High Risk Income equities, is provided.

As will be appreciated by one skilled in the art, further functional extensions can be incorporated to the investment recommendation system 400 to enable an investor to buy the equities on the list 590 directly over the Internet, or to track selected equities, provided the necessary registration and payment processes are supported.

As mentioned earlier, an investor's profile is determined by a combination of the degree of prominence of an investor's AVP characteristic, and the degree of prominence of the investor's IVG characteristic. The method of identifying an investor profile in accordance with the present invention, determines the degrees of prominence of an investor's AVP characteristic and the investor's IVG characteristic, based on the investor's allocations over the different time periods.

Different weights or multipliers are assigned to the different equities over the time periods. These multipliers are assigned to reflect the different market conditions, news and rumors that are provided to the investor.

TABLE 2

| | Month | Month | Month | Month | Final | |
|---|---|---|---|---|---|---|
| | 2 | 6 | 9 | 12 | Allocation | Total |
| Ray-Gene | % × 2 | % × 1 | % × 1 | % × 1 | % × 2 | Score |
| United | % × 1/2 | % × 1/2 | % × 1/2 | % × 1/2 | % × 1 | Score |
| Harvest | | | | | | |

Note:
% = Percentage of investor's total investible assets allocated to that equity

With reference to TABLE 2, in order to determine the degree of prominence of the AVP characteristic of an investor, an AVP algorithm is employed and is described as follows. Each allocation made by the investor, except the first allocation is taken into account. Ray-Gene, which is the growth stock, is accorded a higher weighting compared to United Harvest for the purpose of AVP assessment. For the Ray-Gene equity, the investor allocation for the second month is assigned a weighting of two. This is due to the variety of price and non-price information that is available to the investor that suggests that there has been significant profits made and the risk inherent in the stock is still high. Hence, for Ray-Gene, which is the growth stock, a higher weighting is given compared to United Harvest.

The market conditions are presented to the investor through the variety of information sources to tempt the investor to take profit. However, a continued high allocation by an investor to the Ray-Gene equity would imply that the investor has a low degree of prominence of the AVP characteristic. This indicates that the investor has a greater appetite for risk.

With the final allocation, the investor would have had the experience of the prior twelve-month period, and would therefore be aware of the price volatility of the higher risk growth equity, Ray-Gene. Thus, a high allocation for the Ray Gene equity in the final allocation implies that the investor is willing to accept the higher risk in return for the greater possibility of capital growth.

United Harvest is a relatively less risky equity than that of Ray Gene, but would still generate relatively higher levels of risk with respect to cash and bonds. Therefore, a weighting of 0.5 is assigned to the United Harvest allocations compared to the usual weighting of one.

There is also a weighting assigned for the question on borrowing 565 for investment. The weight given is 0.5 for a ‘Yes’ response and zero for a ‘No’ response.

TABLE 3

| | Month | Month | Month | Month | 2nd | |
|---|---|---|---|---|---|---|
| | 2 | 6 | 9 | 12 | Allocation | Total |
| Ray-Gene | 20% × 2 | 50% | 8% | 40% | 10% × 2 | 1.58 |
| United | 40%/2 | 10%/2 | 25%/2 | 15%/2 | 20% | 0.65 |
| Harvest | | | | | | |

With reference to TABLE 3, an example of the AVP algorithm will now be described. First, scores for the investor's allocations are computed with the respective weightings, and respective total scores determined for each of the equities, Ray-Gene and United Harvest.

$$\underline{CALCULATION 1}$$

$$\begin{matrix}Scoring system : & Total Sum for ray \text{-} gene \\ & + \underline{Total Sum for United Harvest} \\ Add y es to borrowing & \underline{ 0.5} \\ Total AVP score & {}_{\underline{\_}}\end{matrix}$$

Next, with reference to CALCUALTION 1, the scores of the two equities are added to produce a total AVP score, and depending on the investor's response to borrowing to invest 565, an additional 0.5 is added to the total AVP score.

TABLE 4
ASSET VALUE PROTECTION SCORING SCHEME

| TOTAL AVP SCORE | AVP RATING |
|---|---|
| <1.9 | High |
| 1.9-4 | Medium |
| >4 | Low |

With reference to TABLE 4, the total AVP score is then compared using an AVP scoring scheme to determine whether the degree of prominence of the AVP characteristic of the investor corresponds to a high, medium or low rating. If the total AVP score is less than 1.9, then the investor is considered to have a high AVP characteristic. If the investor's score is within the range of 1.9 and 4 then, the investor has a medium AVP characteristic. Any score above 4 would be considered a low AVP characteristic. Hence, a high rating indicates that the investor is keen to preserve the value of his investments and is therefore less likely to take risks, while a low rating indicates that the investor is less concerned about preserving the value of his investments, and is therefore more likely to take risks. Therefore, the higher the total AVP score, the greater the risk the investor is willing to take.

Applying CALCULATION 1 to the example in TABLE 3 produces the calculation below.

$$\begin{matrix}Scoring system : & 1.58 \\ & + \underline{ 0.65} \\ & 2.23 \\ Add y es to borrowing & \underline{ 0.5} \\ Total AVP score & { 2.73}_{\underline{\_}}\end{matrix}$$

With a total AVP score of 2.73, the investor has a medium AVP rating.

TABLE 5

| | 1st. Allocation | Last Allocation | Total |
|---|---|---|---|
| Ray-Gene | % × 1 | % × 2 | |

With reference to TABLE 5, in order to determine the degree of prominence of the IVG characteristic of an investor, an IVG algorithm, is employed is described as follows. To begin, only the first and last allocations for the growth equity Ray-Gene is considered. The first allocation has a weighting of one, however the last allocation is given a higher weighting. This is because, after progressing through the allocations in the first twelve months, the investor would give more thought to the last allocation. Hence, the last allocation is given a double weighting compared to the first allocation.

### EXAMPLE

TABLE 6

| | 1st Allocation | Last Allocation | Total |
|---|---|---|---|
| Ray-Gene | 0.2 | 0.1 | 0.3 |

With reference to TABLE 6, an example of the IVG algorithm will now be described. First, only the first and last investor allocation scores are computed with the respective weightings. Then the respective allocation scores are added to produce a total IVG score.

TABLE 7
INCOME VERSUS GROWTH SCORING SCHEME

| TOTAL IVG SCORE | IVG RATING |
|---|---|
| <1 | High |
| 1-1.5 | Medium |
| >1.5 | Low |

With reference to TABLE 7, the total IVG score is then compared using an IVG scoring scheme to determine whether the degree of prominence of the IVG characteristic of the investor has a high, medium or low rating. If an investor's total IVG score is less than one, this indicates that the investor prefers income to growth. When an investor's total IVG score is between 1 to 1.5, the investor wants a balance between growth and income, and when an investor's total IVG score is greater than 1.5, this indicates that the investor prefers growth.

Referring to the total IVG score from the example in TABLE 6, the investor has a total IVG score of 0.3. From the IVG scoring scheme the corresponds to a high rating. therefore, the investor prefers more income to growth from his investments.

Returning now to TABLE 1, where the investor in the example has a medium AVP rating, and a high IVG rating, the corresponding investor profile is Moderately Consertive. The associated investment portfolio comprises, 60% fixed income funds of 25% Cash and 35% Bonds, and 40% equities made up of 20% Higher Risk quities and 20% Lower Risk Income Equities. The present invention, as described, provides an investor profiler that presents or with an investment environment, and tracks the investor's allocation of investible assets in the investment environment over several simulated time periods. The investors investment characteristics are then determined from the allocations, and the characteristic are used to identify one of a predetermined variety of investment profiles.

This is accomplished by providing the investor with information from a variety of sources and determining from the allocations which of the information sources influenced the investor. Scores are determined from the allocations indicative of the investors AVP and IVG characteristics, and the scores are translated to ratings. The ratings are then used to identify one of a variety of predetermined investor profiles, where the identified investor profile has the corresponding AVP and IVG ratings.

The present invention therefore provides a method and apparatus for identifying investor profile which overcomes, or at least reduces, the above mentioned problems of the prior art.

It will be appreciated that although only one particular embodiment of the invention has been described in detail, various modifications and improvements can be made by a person skilled in the art without departing from the scope of the present invention.

1. A method implemented on a computer system for identifying investor profile of an investor, the method comprising the steps of:
a) presenting an investment environment to the investor, wherein the investment environment includes a plurality of investment instruments;
b) providing the investor with investible assets;

2. providing the investor with information relating to a predetermined initial status of the investment environment;
d) receiving initial allocation data from the investor;
e) allocating the investible assets among the plurality of investment instruments in accordance with the initial allocation data;
f) providing the investor with additional information, wherein the additional information includes updated values of at least one of the plurality of investment instruments, and wherein the additional information includes predetermined information identified as being information from at least one of a variety of predetermined information sources;
g) receiving re-allocation data from the investor;
h) allocating the investible assets among the plurality of investment instruments in accordance with the re-allocation data;
i) repeating steps (f) to (h) a predetermined number of iterations while tracking the re-allocation data for each iteration to produce tracking allocation data; and
j) identifying at least one predetermined investor profile of a plurality of predetermined investor profiles using at least some of the tracking allocation data.

3. A method in accordance with claim 1, wherein step (j) comprises the step of analyzing at least some of the tracking allocation data using a first predetermined algorithm to produce a first degree of prominence of at least a first investment characteristic of the investor.

4. A method in accordance with claim 2 wherein the step of analyzing using the first predetermined algorithm comprises the steps of:
computing a first score using at least some of the re-allocation data in accordance with a first predetermined weighting scheme applied to the at least some of the re-allocation data; and
determining the first degree of prominence of the at least the first investment characteristic using the first score.

5. A method in accordance with claim 3 wherein the step of determining the first degree of prominence of the at least the first investment characteristic comprises the step of determining a degree of prominence of asset value protection characteristic.

6. A method in accordance with claim 4, wherein step (j) comprises the step of analyzing at least some of the tracking allocation data using a second predetermined algorithm to produce a second degree of prominence of at least a second investment characteristic of the investor.

7. A method in accordance with claim 5 wherein the step of analyzing using the second predetermined algorithm comprises the steps of:
computing a second score using at least some of the re-allocation data in accordance with a second predetermined weighting scheme applied to the at least some of the re-allocation data; and
determining the second degree of prominence of the at least the second investment characteristic using the second score.

8. A method in accordance with claim 6 wherein the step of determining the second degree of prominence of the at least the second investment characteristic comprises the step of determining a degree of prominence of income versus growth characteristic.

9. A method in accordance with claim 7, prior to step (j), comprising the step of defining the plurality of predetermined investor profiles.

10. A method in accordance with step 8, prior to step (j) comprising the step of defining a plurality of combinations of the first degree of prominence of the at least the first investment characteristic and the second degree of prominence of the at least the second investment characteristic.

11. A method in accordance with step 9, prior to step (i) comprising the step of associating the plurality of combinations with the plurality of predetermined investor profiles.

12. A method in accordance with claim 1, further comprises prior to step (c), the step of generating the information relating to the predetermined initial status of the investment environment.

13. A method in accordance with claim 11, further comprises prior to step (f), the step of generating at least some of the additional information.

14. A method in accordance with claim 1 wherein step (i) comprising the step of storing the tracking allocation data.

15. A method in accordance with claim 1 wherein step (c) further comprises the step of providing predetermined initial values of at least some of the plurality of investment instruments.

16. A method in accordance with claim 1 wherein step (f) comprises the step of providing a revised value of the investible assets.

17. An apparatus for identifying investor profile of an investor, the apparatus comprising:
a user interface for presenting an investment environment, the investment environment comprising:
an allocator for selecting an initial investment allocation among a predetermined variety of investment instruments, and the allocator for selecting subsequent investment allocations among the variety of investment instruments; and
a plurality of display locations for displaying information, the information comprising current investible assets of the investor, current values of the variety of investment instruments, and information from a variety of information sources, the plurality of display locations for displaying subsequent investible assets of the investor, subsequent values of the variety of investment instruments, and subsequent information from a variety of information sources, and the plurality of display locations for displaying an investor profile of the investor; and
a controller coupled to the user interface for receiving the initial investment allocation and for providing the current investible assets of the investor, current values of the variety of investment instruments, and information from a variety of information sources, the controller for receiving subsequent investment allocations and for providing subsequent investible assets of the investor, subsequent values of the variety of investment instruments, and subsequent information from a variety of information sources, and the controller for determining the investor profile from a variety of predefined investor profiles from at least some of the subsequent investment allocations, and for providing the investor profile to the user interface.

18. An apparatus in accordance with claim 16, wherein the controller comprises a memory for storing the variety of predefined investor profiles.

19. An apparatus in accordance with claim 17, wherein the controller comprises an investment environment processor for analyzing the at least some of the subsequent investment allocations, and for identifying the investor profile from the variety of predefined investor profiles.

20. An apparatus in accordance with claim 18 wherein the investment environment processor is coupled to receive the initial and the subsequent investment allocations, and the investment environment processor for computing the subsequent values of the variety of investment instruments.

21. An apparatus in accordance with claim 19, wherein the controller comprises a memory for storing the current values of the variety of investment instruments, information from a variety of information sources, and the subsequent information from the variety of information sources.

22. A method implemented on a computer system for solving a technical problem of automatically providing an optimal investor profile of an investor with respect to the investor's private investment strategy, the method comprising the steps of:
a) presenting an investment environment to the investor through the use of a user interface screen displayed by a browser, wherein the investment environment includes a plurality of investment instruments;
b) providing the investor with exemplary investible assets;
c) providing the investor with information relating to a predetermined initial status of the investment environment;
d) receiving initial allocation data from the investor;
e) allocating the investible assets among the plurality of investment instruments in accordance with the initial allocation data;
f) providing the investor with additional information, wherein the additional information includes updated values of at least one of the plurality of investment instruments, and wherein the additional information includes predetermined information identified as being information from at least one of a variety of predetermined information sources;
g) receiving re-allocation data from the investor;
h) allocating the investible assets among the plurality of investment instruments in accordance with the re-allocation data;
i) repeating steps (f) to (h) a predetermined number of iterations while tracking the re-allocation data for each iteration to produce tracking allocation data; and
j) identifying at least one predetermined investor profile of a plurality of predetermined investor profiles using at least some of the tracking allocation data.

23. A method implemented on a computer system for solving a technical problem of automatically providing an optimal investor profile of an investor with respect to the investor's private investment strategy, the method comprising the steps of:
a) presenting an investment environment to the investor through the use of a user interface screen displayed by a browser, wherein the investment environment includes a plurality of investment instruments and exemplary investible assets;
b) receiving initial allocation data for the exemplary investible assets from the investor;
c) allocating the investible assets among the plurality of investment instruments in accordance with the initial allocation data;
d) providing the investor with additional information, wherein the additional information includes updated values of at least one of the plurality of investment instruments, and wherein the additional information includes predetermined information identified as being information from at least one of a variety of predetermined information sources;
e) receiving re-allocation data from the investor;
f) allocating the investible assets among the plurality of investments in accordance with the re-allocation data; and
g) identifying at least one predetermined investor profile of a plurality of predetermined investor profiles based upon user's inputted allocation data.
